(19) United States
(12) Patent Application Publication
(10) Pub. No.: US 2025/0306265 A1
(43) Pub. Date: Oct. 2, 2025

(54) OPTICAL INTEGRATED CIRCUIT ELEMENT

(71) Applicant: NEC Corporation, Tokyo (JP)

(72) Inventor: Ryo KURAHASHI, Tokyo (JP)

(73) Assignee: NEC Corporation, Tokyo (JP)

(21) Appl. No.: 19/074,675

(22) Filed: Mar. 10, 2025

(30) Foreign Application Priority Data
Mar. 28, 2024 (JP) 2024-054274

(51) Int. Cl. G02B 6/12

(52) U.S. Cl. CPC G02B 6/12004; G02B 6/12007; G02B 2006/12109; G02B 2006/12121; G02B 2006/12123; G02B 2006/12135; G02B 2006/12138; G02B 2006/1215

(57) ABSTRACT

An optical integrated circuit element according to the present disclosure includes: a first optical circuit element and a second optical circuit element each requiring temperature control; and a temperature sensor configured to measure temperatures of the first optical circuit element and the second optical circuit element.

### INCORPORATION BY REFERENCE

This application is based upon and claims the benefit of priority from Japanese patent application No. 2024-054274, filed on Mar. 28, 2024, the disclosure of which is incorporated herein in its entirety by reference.

### TECHNICAL FIELD

The present disclosure relates to an optical integrated circuit element.

### BACKGROUND ART

A light source (multi-wavelength laser source: MWLS) for outputting laser beams of a plurality of wavelengths that differ from one another is known (for example, see Patent Literature 1).

An MWLS in Patent Literature 1 includes two laser drivers and two wavelength lockers, being associated with the two laser drivers, for fixing optical wavelengths of the two laser drivers to a target wavelength.

[Patent Literature 1] US Patent Publication No. 2005/0063429, Description

### SUMMARY

The wavelength locker includes a monitoring unit configured to monitor a wavelength (frequency) of light to be output from the laser driver. The monitoring unit may include a ring resonator or the like as an optical filter. Characteristics of the ring resonator or the like tend to change due to temperature. Therefore, in order to correctly measure the wavelength, it is necessary to control the temperature of the monitoring unit to a target temperature associated with the target wavelength.

The present inventors have found a problem that, when a plurality of temperature sensors each associated with each of a plurality of wavelength lockers are provided in an optical integrated circuit element, the optical integrated circuit element becomes large in size. Especially, in a case of the optical integrated circuit element, this problem becomes remarkable. Further, this problem is not limited to the wavelength locker, and may occur in any optical circuit element that requires temperature control.

An example object of the present disclosure is to provide an optical integrated circuit element capable of avoiding an increase in size. It should be noted that this object is merely one of objects to be achieved by a plurality of example embodiments disclosed herein. Other objects or problems and novel features will be apparent from the present description or the accompanying drawings.

In an example aspect of the present disclosure, an optical integrated circuit element includes a first optical circuit element and a second optical circuit element each requiring temperature control, and a temperature sensor configured to measure temperatures of the first optical circuit element and the second optical circuit element.

An example advantage according to the above-described example embodiments is that it is possible to provide an optical integrated circuit element being capable of avoiding an increase in size.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating one example of an optical integrated circuit element according to the present disclosure;

FIG. 2 is a diagram for describing an arrangement of an optical circuit element and a temperature sensor in the optical integrated circuit element according to the present disclosure;

FIG. 3 is another diagram for describing the arrangement of the optical circuit element and the temperature sensor in the optical integrated circuit element according to the present disclosure; and

FIG. 4 is a diagram illustrating one example of a light output apparatus according to the present disclosure.

### EXAMPLE EMBODIMENT

Hereinafter, example embodiments will be described with reference to the drawings. Note that, in the present disclosure, the drawings may be associated with one or more example embodiments. Also, the elements of the drawings may apply to one or more example embodiments. In addition, in the example embodiments, the same or equivalent elements are denoted by the same reference numerals, and redundant description thereof will be omitted.

### First Example Embodiment

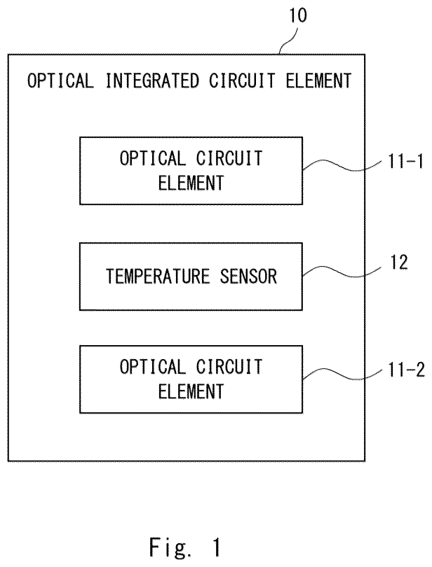

FIG. 1 is a diagram illustrating one example of an optical integrated circuit element according to the present disclosure. In FIG. 1, an optical integrated circuit element 10 includes optical circuit elements 11-1 and 11-2 and a temperature sensor 12. Note that, in the following description, when the optical circuit elements 11-1 and 11-2 are not distinguished from each other, the optical circuit elements 11-1 and 11-2 may be each referred to or may be collectively referred to as an optical circuit element 11.

The optical circuit element 11 is an element requiring temperature control. The optical circuit element 11 may be, for example, a circuit element (monitoring unit) that includes a ring resonator (not illustrated) as an optical filter and monitors the wavelength (frequency) of light, as described above.

The temperature sensor 12 measures the temperature of the optical circuit element 11-1 and the optical circuit element 11-2.

As described above, the optical integrated circuit element 10 according to the first example embodiment includes the optical circuit elements 11-1 and 11-2 and the temperature sensor 12 configured to measure the temperatures of the optical circuit element 11-1 and the optical circuit element 11-2.

According to the configuration of the optical integrated circuit element 10, it is possible to reduce the size of the optical integrated circuit element as compared with a case where a temperature sensor is provided for each of the optical circuit elements.

Although a case where two optical circuit elements 11 and one temperature sensor 12 are included has been described for the sake of simplicity, the present disclosure is not limited to this. For example, in a case where three optical circuit elements 11-1, 11-2, and 11-3 are included, the optical integrated circuit element 10 may include one temperature sensor 12 for measuring the temperatures of the optical circuit elements 11-1 and 11-2 and another temperature sensor 12 for measuring the temperatures of the optical circuit elements 11-2 and 11-3. In short, it is only necessary that the optical integrated circuit element 10 has a smaller number of temperature sensors 12 than the number of the optical circuit elements 11, and the temperature of the optical circuit element 11 can be measured by the temperature sensor 12.

### Second Example Embodiment

A second example embodiment relates to an arrangement of an optical circuit element and a temperature sensor.

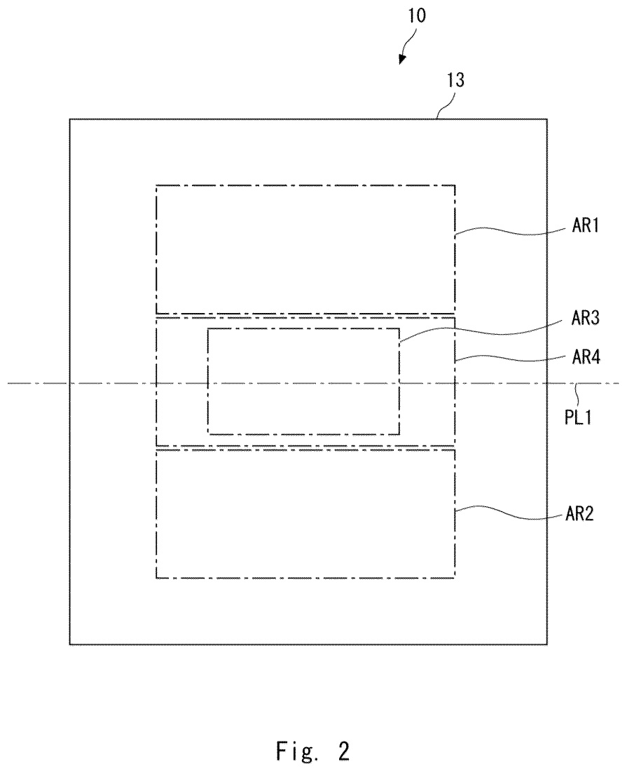

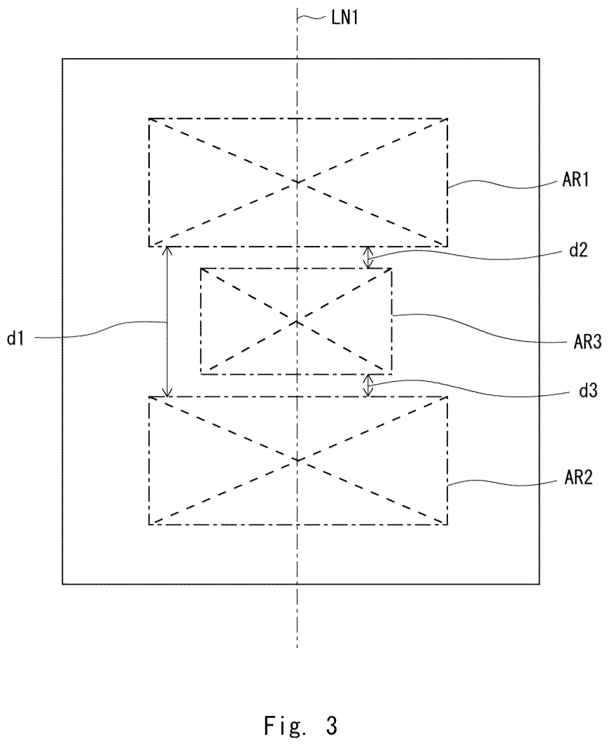

FIG. 2 is a diagram for describing an arrangement of an optical circuit element and a temperature sensor in the optical integrated circuit element according to the present disclosure. FIG. 3 is another diagram for describing the arrangement of the optical circuit element and the temperature sensor in the optical integrated circuit element according to the present disclosure.

As illustrated in FIG. 2, an optical integrated circuit element 10 includes a plate-shaped substrate 13. Optical circuit elements 11-1 and 11-2 are respectively disposed in disposition areas AR1 and AR2 on the substrate 13 illustrated in FIG. 2. Further, a temperature sensor 12 is disposed in a disposition area AR3 on the substrate 13 illustrated in FIG. 2.

The disposition area AR1 and the disposition area AR2 are located at positions symmetrical with respect to a plane of symmetry PL1 orthogonal to the plane of the substrate 13. The disposition area AR3 is included in an area AR4 interposed between the disposition area AR1 and the disposition area AR2. Thereby, the optical circuit elements 11-1 and 11-2 and the temperature sensor 12 may be efficiently arranged.

For example, the disposition area AR1 and the disposition area AR2 have a rectangular shape congruent with each other. The disposition area AR3 also has a rectangular shape. The disposition area AR3 may or may not be congruent with each of the disposition area AR1 and the disposition area AR2. Further, for example, the center of gravity of the disposition area AR1, the center of gravity of the disposition area AR2, and the center of gravity of the disposition area AR3 may exist on a straight line LN1. Accordingly, the temperature sensor 12 can accurately measure the temperature of the central portion (that is, the portion associated with the straight line LN1) of the optical circuit element 11 where it is assumed to have the highest temperature in the optical circuit element 11.

Further, a separation distance dl between the disposition area AR1 and the disposition area AR2 is, for example, equal to or larger than a length required for placing the temperature sensor 12, and equal to or larger than a distance (for example, 300 μm) that can be assumed that no thermal interference between the optical circuit element 11-1 and the optical circuit element 11-2 occurs. A separation distance d2 between the disposition area AR1 and the disposition area AR3 and a separation distance d3 between the disposition area AR2 and the disposition area AR3 are each 0 μm to 300 μm, for example.

As described above, according to the second example embodiment, in the optical integrated circuit element 10, each of the optical circuit element 11-1 and the optical circuit element 11-2 are arranged respectively in the disposition area AR1 and the disposition area AR2 being located on the substrate 13 at positions symmetrical with respect to the plane of symmetry PL1 orthogonal to the substrate 13 and being separated from each other by a predetermined distance. The temperature sensor 12 is disposed in the disposition area AR3 being included in the area AR4 interposed between the disposition area AR1 and the disposition area AR2 on the substrate 13.

According to the configuration of the optical integrated circuit element 10, the optical circuit elements 11-1 and 11-2 and the temperature sensor 12 can be efficiently arranged on the substrate 13, making it possible to further reduce the size thereof.

### Third Example Embodiment

A third example embodiment relates to a light output apparatus.

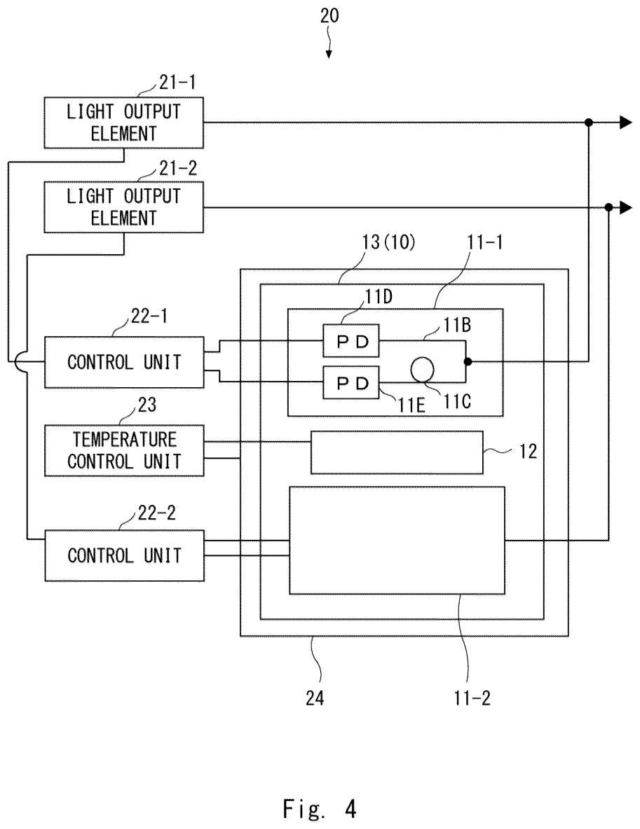

FIG. 4 is a diagram illustrating one example of a light output apparatus according to the present disclosure. In FIG. 4, a light output apparatus 20 includes light output elements 21-1 and 21-2, control units 22-1 and 22-2, a temperature control unit 23, a thermo-electric cooler (TEC) element 24, and an optical integrated circuit element 10.

The light output element 21-1 outputs light of a first wavelength (hereinafter, sometimes referred to as “first light”). The light output element 21-2 outputs light of a second wavelength (hereinafter, sometimes referred to as “second light”). That is, the light output apparatus 20 is a wavelength tunable light source involving two wavelengths. The first wavelength and the second wavelength may be the same or different. Note that, although wavelength is described herein, frequency may be used instead of the wavelength.

The first light is split by an optical splitter, and a part of the first light is input to an optical circuit element 11-1 of the optical integrated circuit element 10. Further, the second light is split by an optical splitter, and a part of the second light is input to an optical circuit element 11-2 of the optical integrated circuit element 10.

The optical circuit element 11 includes a waveguide 11B, an optical filter 11C, and photodiodes (PDs) 11D and 11E. The first light input to the optical circuit element 11-1 is split by the optical splitter of the optical circuit element 11. Then, a part of the first light split by the optical splitter is input to the PD 11D through the waveguide 11B that transmits the light as it is. Then, the PD 11D outputs, to the control unit 22-1, an electric signal according to the intensity of the light received via the waveguide 11B. Further, another part of the first light split by the optical splitter is input to the PD 11E through the optical filter 11C that transmits light with a transmittance according to the wavelength. The optical filter 11C includes a ring resonator. Then, the PD 11E outputs, to the control unit 22-1, an electric signal according to the intensity of the light received via the optical filter 11C. The value of the ratio of the current value of the electrical signal received from the PD 11D to the current value of the electrical signal received from the PD 11E is equivalent to a monitored value relating to the wavelength of the first light.

The control unit 22-1 controls the optical circuit element 11-1 in such a way that the wavelength of the light being output from the optical circuit element 11-1 approaches the target wavelength, based on the monitored value related to the wavelength of the first light and the target wavelength of the first light.

Note that, the optical circuit element 11-2 has the same configuration as the basic configuration of the optical circuit element 11-1. Further, the optical circuit element 11-2 and the control unit 22-2 operates similarly to the optical circuit element 11-1 and the control unit 22-1 with respect to the second light.

The temperature control unit 23 controls the TEC element 24, based on the measured temperature received from the temperature sensor 12 and the target temperature, thereby performing control to bring the measured temperature closer to the target temperature. The target temperature is a temperature associated with the target wavelength of the first light and the target wavelength of the second light. The optical circuit elements 11-1 and 11-2 and the temperature sensor 12 are disposed on the TEC element 24. Therefore, by performing control to bring the measured temperature of the temperature sensor 12 closer to the target temperature, the temperatures of the optical circuit elements 11-1 and 11-2 can be brought closer to the target temperature. The TEC element 24 is, for example, a Peltier element.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An optical integrated circuit element including:

a first optical circuit element and a second optical circuit element each requiring temperature control; and

a temperature sensor configured to measure temperatures of the first optical circuit element and the second optical circuit element.

### Supplementary Note 2

The optical integrated circuit element according to supplementary note 1, wherein

the first optical circuit element and the second optical circuit element are respectively disposed in a first disposition area and a second disposition area that are located on a substrate at positions symmetrical with respect to a plane of symmetry orthogonal to the substrate and are separated from each other by a predetermined distance, and

the temperature sensor is disposed in a third disposition area being included in an area interposed between the first disposition area and the second disposition area on the substrate.

### Supplementary Note 3

The optical integrated circuit element according to supplementary note 1 or 2, wherein each of the first optical circuit element and the second optical circuit element includes a ring resonator type wavelength filter.

### Supplementary Note 4

The optical integrated circuit element according to supplementary note 3, wherein the first optical circuit element is a monitoring unit configured to monitor a wavelength of light being output by a first light output element, and

the second optical circuit element is a monitoring unit configured to monitor a wavelength of light being output by a second light output element.

### Supplementary Note 5

The optical integrated circuit element according to supplementary note 2,wherein

the predetermined distance is a distance that can be assumed that no thermal interference between the first optical circuit element and the second optical circuit element occurs, and

a separation distance between the first optical circuit element and the temperature sensor and a separation distance between the second optical circuit element and the temperature sensor are each 0 μm to 300 μm.

### Supplementary Note 6

The optical integrated circuit element according to supplementary note 5, wherein the predetermined distance is 300 μm or more.

What is claimed is:

1. An optical integrated circuit element comprising:
a first optical circuit element and a second optical circuit element each requiring temperature control; and
a temperature sensor configured to measure temperatures of the first optical circuit element and the second optical circuit element.

2. The optical integrated circuit element according to claim 1, wherein
the first optical circuit element and the second optical circuit element are respectively disposed in a first disposition area and a second disposition area that are located on a substrate at positions symmetrical with respect to a plane of symmetry orthogonal to the substrate and are separated from each other by a predetermined distance, and
the temperature sensor is disposed in a third disposition area being included in an area interposed between the first disposition area and the second disposition area on the substrate.

3. The optical integrated circuit element according to claim 1, wherein each of the first optical circuit element and the second optical circuit element includes a ring resonator type wavelength filter.

4. The optical integrated circuit element according to claim 3, wherein
the first optical circuit element is a monitoring unit configured to monitor a wavelength of light being output by a first light output element, and
the second optical circuit element is a monitoring unit configured to monitor a wavelength of light being output by a second light output element.

5. The optical integrated circuit element according to claim 2, wherein
the predetermined distance is a distance that can be assumed that no thermal interference between the first optical circuit element and the second optical circuit element occurs, and
a separation distance between the first optical circuit element and the temperature sensor and a separation distance between the second optical circuit element and the temperature sensor are each 0 μm to 300 μm.

6. The optical integrated circuit element according to claim 5, wherein the predetermined distance is 300 μm or more.
